(19) United States
(12) Patent Application Publication
(10) Pub. No.: US 2025/0118156 A1
(43) Pub. Date: Apr. 10, 2025

(54) GENERATING CURATED NATURAL LANGUAGE EXPRESSIONS FOR GAMING TICKET APPLICATIONS

(71) Applicant: SB22, Inc., Dallas, TX (US)

(72) Inventor: Vladimir Jovanovic, Belgrade (RS)

(21) Appl. No.: 18/908,442

(22) Filed: Oct. 7, 2024

Related U.S. Application Data
(60) Provisional application No. 63/588,535, filed on Oct. 6, 2023.

(51) Int. Cl. G07F 17/32; G06F 40/186; G06Q 50/34

(52) U.S. Cl. CPC G07F 17/323; G06F 40/186; G06Q 50/34; G07F 17/3288

(57) ABSTRACT

The present disclosure, among other benefits, provide a technological solution which leverages electronic templates, information systems, and/or machine learning to generate gaming tickets which automatically generate and provide natural language descriptions of gaming opportunities. Aspects disclosed herein provide a wagering ticket win curation system, integrated with an online and/or retail sportsbook platform, to assist players during bet selection and placement, additionally documenting the winning outcomes of a placed wager in a plain language, in a manner that is easy to comprehend.

### CROSS-REFERENCE TO RELATED APPLICATIONS

This application claims priority to U.S. Provisional Patent Application Ser. No. 63/588,535, filed Oct. 6, 2023, entitled “GENERATING CURATED NATURAL LANGUAGE EXPRESSIONS,” which is incorporated herein by reference in its entirety.

### BACKGROUND

Gaming tickets are generated with odds described in a format which may be hard for players to decipher. Existing solutions, however, do not have the capability to generate a natural language expression that clearly conveys the gaming opportunity to a player.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to generating a natural language expression using a curation engine. The curation engine receives information about a gaming selection. The information may be parsed to identify one or more parameters associated with the gaming selection. Electronic templates are used to generate a curated natural language expression which represents an explanatory description of gaming selection. Alternatively, or additionally, one or more machine learning models may be used to generate the curated natural language expression.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary system with a curation engine, according to aspects described herein.

FIG. 2 is a block diagram illustrating an exemplary method for generating curated natural language expressions.

FIG. 3 is a block diagram illustrating an exemplary method for generating curated natural language expressions using electronic templates.

FIG. 4 is a block diagram illustrating an exemplary method 400 for generating curated natural language expressions using one or more machine learning models.

FIG. 5 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

In existing gaming systems (e.g., a sports wagering system, online gaming apps, etc.), a “market” denotes a specific event, for example an event in a sports contest, on which a bet can be placed, (e.g., for a particular team to win a game outright, or a particular player to score the first point of a game, or that the total points scored in a game are above or below a certain number, etc.), a selection can be made, or is associated with a contest. In a sporting example, an individual wager placed by a player consists of a “betslip”, i.e., a selection of markets picked from the betting offer that the system presents to the player. For case of discussion, aspects of this disclosure will be described in an environment that consists of sports contests. However, one of skill in the art will appreciate that the aspects disclosed herein can be practiced in other wagering or gaming environments without departing from the scope of the present disclosure.

A gaming ticket (e.g., a wagering ticket, a contest ticket, a betslip, etc.) often has several markets, all of which need to be observed as a set when determining the winning outcome. In some types of complex, combinational systems, the winning outcome of the overall wager is determined by a combination of individual outcomes (e.g., in a “3/5 round robin” system, a wager may result in a win if at least 3 of the 5 events picked result in a win, producing 10 unique winning combinations). Additionally, across different systems, different markets, etc., the outcomes of the wagering events are not always presented in a straightforward way (e.g., wagering on a “spread” market which has a basketball team listed as “−3.5” stands to denote the team needing to win by at least 4 points to result in a winning outcome).

In examples, the betting offer consists of markets and their odds described in a numerical format, which conforms to local notational conventions (e.g. in the US markets, odds of “−200” correspond to the player needing to risk 200 monetary units to potentially win 100 more; in the European markets, those same odds would be denoted as “1.50” in the decimal convention, while the fractional system used in the UK would have those odds written as “1/2”). Therefore, the exact monetary values behind those odds may not be immediately obvious to players.

All of the above factors can serve as a detriment to players understanding their wagering options, winning combinations, and associated risks and rewards. Because of this, existing technological solutions make it prohibitive for many of the novice sports wagering players to take full advantage of the wagering system, instead either limiting players to simplified selection subset, rendering it so that players are not able to wager at all, or players end up wagering without precise knowledge of what to expect as the outcome. However, prior wagering systems were not capable of generating clear, concise, and straightforward descriptions of wagering opportunities due to a number of factors. For example, wagering systems include a vast amount of data detailing different betting opportunities, different markets and odds, billions of different winning combinations, and real-time updates to betting opportunities (i.e., different wagering opportunities become available in real-time during a live sporting match). Because of these factors, prior solutions were not capable of processing the vast amount of data, both existing data and data created in real-time, to analyze the different wagering opportunities to generate clear, concise descriptions of wagers. This is due to technological limitations in both hardware and software, network bandwidth and latency issues, software limitations, geographic restrictions and differences, among other issues. Aspects of the present disclosure provide a technical solution which overcome these technical issues by employing the various technological solutions described herein.

For example, aspects of the present disclosure, among other benefits, provide a technological solution which leverages electronic templates, information systems, and/or machine learning to generate gaming tickets which automatically generate and provide natural language descriptions of gaming opportunities. Aspects disclosed herein provide a wagering ticket win curation system, integrated with an online and/or retail sportsbook platform, to assist players during bet selection and placement, additionally documenting the winning outcomes of a placed wager in a plain language, in a manner that is easy to comprehend. By employing these different technological solutions, aspects disclosed herein are operable to process vast amounts of data despite the hardware limitations of various wagering systems.

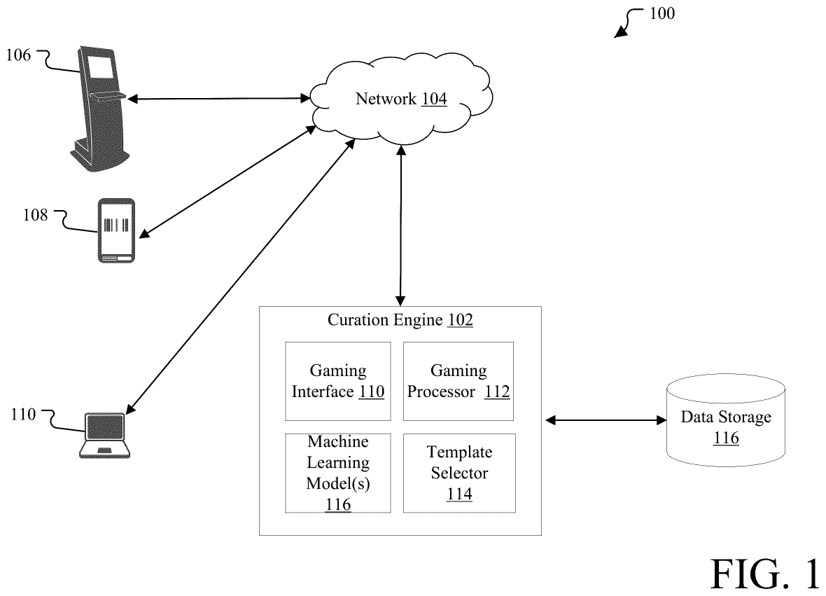

FIG. 1 depicts an exemplary system 100 with a curation engine, according to aspects described herein. System 100 includes a curation engine 102 which is operable to connect to a variety of different devices or systems via network 104. For example, as shown in FIG. 1, curation engine 102 is connected to a kiosk 106, a smartphone 108, for example, a smartphone executing a gaming application (e.g., accessing a gaming website, a waging application, a video game, etc.), and/or a personal computer 110 (e.g., accessing a gaming website, a waging application, a video game, etc.). Although a specific number and type of devices are shown in FIG. 1, one of skill in the art will appreciate any number and type of device may be employed without departing from the scope of this disclosure.

The curation engine 102, as shown in system 100, may be an online component capable of connecting to various different systems. Alternatively, or additionally, the curation engine 102 may be executed locally on a device, such as part of the kiosk 106, a component of a gaming application on a smartphone 108 or personal computer 110, etc. The curation engine is operable to assist players with making gaming selections. For example, the curation engine 102 may be operable to assist players during bet selection and placement, additionally documenting the winning outcomes of a placed wager in a plain language, in a manner that is easy to comprehend particularly for novice users. In doing so, among other benefits, the curation engine is operable to generate a simple user interface that can present information to users in an intuitive manner. As shown in FIG. 1, the curation engine 102 may include a number of different components, such as the gaming interface 110, gaming processor 110, one or more machine learning model(s) 110, and template selector 114. In examples, the one or more machine learning model(s) 110 may be a transformer model, a generative machine learning model, etc.

Gaming interface 110 receives gaming selections from a player using a device, such as kiosk 106, smartphone 108, and personal computer 110. Gaming selections received at one of the devices are transmitted via network 104 and received by the gaming interface 110. In examples, the gaming interface 110 may receive a selection of a bet which includes the type of bet, the amount of the bet, the odds associated with the bet, etc. The information about the bet may be stored in metadata and transmitted with a request to view or place a specific bet. In further examples, the gaming interface may receive information associated with a plurality of bets which may be individual bets or a combination of bets, e.g., a parlay. Upon receiving the gaming selection, the gaming information for the one or more gaming selections are provided to the gaming processor 112. As such, among providing other functions, the gaming interface is operable to communicate with a vast amount of remote devices via a network or on a local device through by exposing one or more different application programming interfaces (APIs) of the curation engine.

Gaming processor 112 may be operable to receive the gaming information and process the gaming information to generate a natural language expression which explains the gaming selection, winning conditions for the gaming selection, or the like. In one example, the gaming processor 112 may identify specific data in the gaming information and use the specific data to locate an associated template to generate a natural language expression. For example, the specific data may be passed to the template selector 114, which can use the specific data to select a relevant template to generate the natural language expression. For example, the specific data may be used when accessing a lookup table to identify a template associated with the gaming selection. The template my be identified using the lookup table and retrieved, for example, from data store 116. The retrieved template may then be provided to the gaming processor 112, which in turn will use the template along with the gaming information to generate a natural language expression which explains the gaming selection, winning conditions for the gaming selection, etc. The use of templates by the gaming processor 112 can be used in situations in which the underlying betting data is well known (e.g., commonly placed bets or odds, related to data that has been to the system for longer periods of time, etc.) in a computationally efficient manner. That is, the templates provide a computationally efficient solution to process existing data or known data without requiring specialized hardware or software.

Alternatively, or additionally, one or more machine learning models 116 may be accessed to generate a natural language expression. In one example, the gaming processor 112 may generate one or more feature vectors based upon the received gaming information. The generated feature vectors may be processed using the one or more machine learning models 116 to generate a natural language expression. Alternatively, or additionally, the one or more machine learning models 116 may receive an associated template from the template selector 114 in addition to the feature vectors. The one or more machine learning models 116 may use the template as an additional signal input when generating the natural language expression.

In examples, the one or more machine learning models 116 may be trained to generate a natural language expression using a set of labeled data. For example, a labeled data set which matches gaming information to a correct natural language expression which documents the winning outcomes of a placed wager in a plain language, an explanations of the wager, etc., may be used to train the one or more machine learning model(s) 116. By training the one or more machine learning models 116 accordingly, the one or more machine learning models 116 may be leveraged to generate natural language expressions which detail the gaming selection, win conditions, etc. The training process updates the machine learning model(s) 116 to generate one or more specialized machine learning models operable to efficiently translate gaming data into natural language expressions. The machine learning model(s) 116 may be trained periodically as the curation engine receives new gaming data, based upon feedback and selections received from the devices in response to presenting the natural language expressions, etc. The periodic training of the models helps to optimize the curation engine 102 to generate natural language expressions efficiently in and ensure that the natural language expressions generated by the machine learning model(s) 116 are helpful to users. For example, by periodically training the models based upon feedback (e.g., in the form of direct feedback from users, indirect feedback, such as the acceptance or rejection of a bet, etc.) the machine learning model(s) 116 can be updated to produce natural language expressions that are helpful to end users. Furthermore, periodic updating can ensure that the one or more machine learning model(s)

The following Table 1 provides exemplary curated natural language expressions:

TABLE 1

| Player Selection(s) on a Betslip | Curated Natural Language Expressions |
|---|---|
| LV Raiders @ GB Packers: LV | If Las Vegas Raiders win the game by 4 points or |
| Raiders −3.5, +100 | more, you will double your wagered money. |
| Nashville @ Tampa Bay, 2^{nd} | If the sum of goals scored by Nashville and Tampa |
| Period Total: O 1.5, +200 | Bay during 2^{nd} period is 2 or more, your payout will |
| | be 3x of what you wager. |
| 2's x3 Round Robin, money line, | You have wagered $30 total on outright wins in a |
| $10 per leg wager placed: | three-team round-robin system (Patriots, Ravens, |
| Patriots @ Jets: Patriots +100 | Raiders). If all three teams win their games, your |
| Steelers @ Ravens: Ravens +100 | payout will be $120. If any two teams win, your |
| Raiders @ Broncos: Raiders +100 | payout will be $40. |

Upon generating one or more curated natural expressions, the one or more curated natural language expressions can be returned to a requesting device via the gaming interface 110. For example, the gaming interface 110 can package the natural language expression for electronic transmission back to a device, such as kiosk 106, smartphone 108, or personal computer 110 and cause the device's user interface to display the natural language expression.

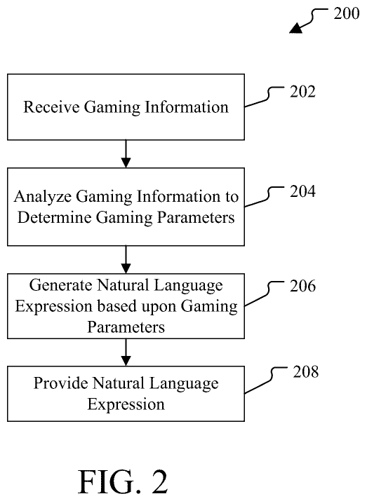

FIG. 2 is a block diagram illustrating an exemplary method 200 for generating curated natural language expressions. Flow begins at operation 202, where gaming information is received, for example, from a gaming device (e.g., a console, a wagering kiosk, etc.), a gaming application (e.g., a sportsbook application, a video game, etc.), and/or a gaming system (e.g., a sportsbook). In examples, game information may be received individually (e.g., as individual wagers), in combinations (e.g., parlays), or in bulk (e.g., multiple individual wagers). In examples, the gaming information may be received in real-time, or near real-time, as a player interacts with a gaming device, gaming application, etc.

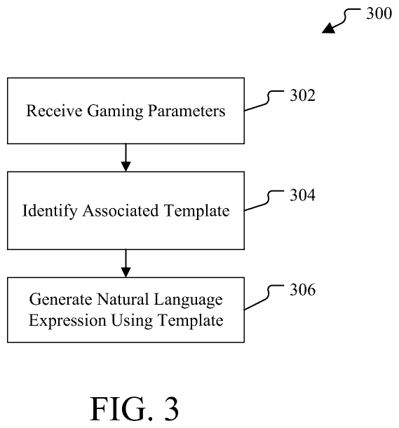

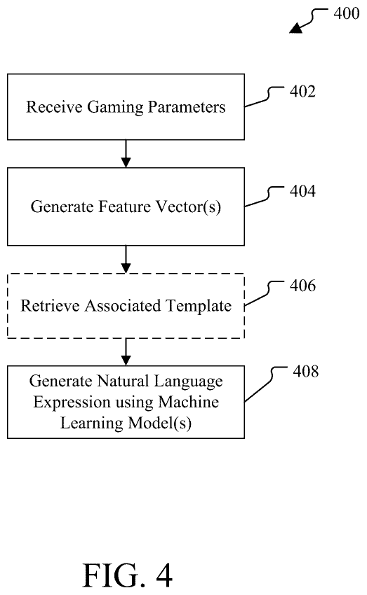

Flow continues to operation 204, where the gaming information is analyzed to determine one or more gaming parameters. In examples, the gaming information may be determined by analyzing a gaming selection. Alternatively, or additionally, gaming information may be metadata associated with the request to generate an explanatory natural language expression for the gaming selection. The parameters can include, but are not limited to, a market, a location of the game, a game identifier, odds for the gaming selection, time and date information, etc. Flow continues to operation 206, where a curated natural language expression is generated based upon the determined parameters. The curated natural language expression may be generated using electronic templates, generative machine learning models, or a combination of the two. The process for generating the curated natural language expressions is described in more detail in FIGS. 3 and 4. In examples, a determination of whether to use a template, a natural language model, or a combination of both may be made based upon an analysis of the gaming data. For example, if the gaming data is well known data (e.g., related to commonly placed bets, based upon older data in the system, etc.) a template may be used to reduce the computational resources required to generate the natural language expression. On the other hand, if the gaming data is not well known (e.g., based upon real-time or near real-time data, related to a game currently in progress, or an uncommon bet), a machine learning model may be used to generate the natural language expression. Use of a natural language model to generate the expression allows the method 200 to be responsive to new data in a timely manner, thereby ensuring the generation of natural language expressions. A combination of techniques may be used for batch data requests, for example.

Upon generating the curated natural language expression, the generated natural language expressions are provided to a requesting device at operation 208, displayed on a local device performing the method 200, or cause to be displayed on a remote device. In examples, each gaming selection is assigned an explanatory value in a natural language format required by the requesting device, such that it can be adequately presented to the player when needed. The natural language expression can be presented in a user interface in multiple ways, depending on the user interface of the requesting device. For example, the natural language expression can be displayed as a tooltip or other type of text overlay, as a popup shown on player's demand, as an audio explanation using text-to-speech, or any other type of communication with the player as adequate. Additionally, or alternatively, providing the natural language expression can include causing a device to generate a printed betslip which includes the natural language expression and a confirmation of the game selection. In still further examples, the documentation generated after successful game selection can be shown as a part of the game details (e.g., in player's gaming history), sent to player's email address, printed out on a retail ticket slip, etc.

FIG. 3 is a block diagram illustrating an exemplary method 300 for generating curated natural language expressions using electronic templates. Flow begins at operation 302, where gaming parameters are received. As previously discussed, the parameters can include, but are not limited to, a market, a location of the game, a game identifier, odds for the gaming selection, time and date information, etc. One of skill in the art will appreciate that other types of parameters may be received or determined without departing from the scope of this disclosure. Flow continues to operation 304 where, based upon one or more of the received parameters, an associated electronic template is identified. For example, the gaming parameters may be used as an index to search a lookup table to identify an electronic template that is can be used to generate an appropriate natural language expression based upon the selected gaming opportunity. Using the lookup table, a template can be retrieved from a template data store. Alternatively, if an appropriate template does not exist, a template may be generated, at operation 304, based upon the received gaming parameters. In examples, a template my be generated based upon the gaming parameters. For example, an existing template may be modified in order to create a new template based upon the gaming parameters. Alternatively, or additionally, a machine learning model may be used to generate a new template. The template generation machine learning model may be trained using existing templates and related gaming parameters in order to generate new templates upon receipt of new gaming parameters.

Flow continues to operation 306 where, using one or more retrieved electronic templates and the gaming parameters, a natural language expression detailing the game selection and/or the win conditions is generated. The natural language expression can be presented in a user interface in multiple ways, depending on the user interface of the requesting device. For example, the natural language expression can be displayed as a tooltip or other type of text overlay, as a popup shown on player's demand, as an audio explanation using text-to-speech, or any other type of communication with the player as adequate. Additionally, or alternatively, providing the natural language expression can include generating a printed betslip which includes the natural language expression and a confirmation of the game selection. In still further examples, the documentation generated after successful game selection can be shown as a part of the game details (e.g., in player's gaming history), sent to player's email address, printed out on a retail ticket slip, etc.

FIG. 4 is a block diagram illustrating an exemplary method 400 for generating curated natural language expressions using one or more machine learning models. Flow begins at operation 402, where gaming parameters are received. As previously discussed, the parameters can include, but are not limited to, a market, a location of the game, a game identifier, odds for the gaming selection, time and date information, etc. One of skill in the art will appreciate that other types of parameters may be received or determined without departing from the scope of this disclosure. The parameters can be received from a remote device, such as a kiosk, smartphone, etc. Alternatively, the parameters may be received from a user interface of the device performing the method 400.

Flow continues to operation 404, where one or more feature vectors are generated based upon the gaming parameters. In one example, the generated feature vectors may represent the characteristics of a gaming selection as defined by the gaming parameters. The feature vectors may be generated and provided to a machine learning model. Alternatively, or additionally, operation 404 can include preprocessing the gaming parameters to transform them into a format (e.g., a text description) that can be provided to a machine learning model. One of skill in the art will appreciate that any type of format or feature vector may be generated at operation 404 depending on the type of machine learning models employed for use by the method 400.

In examples, flow may proceed to optional operation 406 where one or more templates associated with the gaming parameters may be identified and retrieved. As previously discussed, based upon one or more of the received gaming parameters, an associated electronic template is identified. For example, the gaming parameters may be used as an index to search a lookup table to identify an electronic template that is can be used to generate an appropriate natural language expression based upon the selected gaming opportunity. Using the lookup table, a template can be retrieved from a template data store. Alternatively, if an appropriate template does not exist, a template may be generated, at operation 406, based upon the received gaming parameters as previously discussed. In examples, the one or more retrieved electronic templates may be provided to a machine learning model, in addition to the gaming parameters, to generate a natural language expression.

Flow continues to operation 408, where the feature vectors (or other data format, e.g., text descriptions of parameters) and, optionally, the one or more templates, are provided as signal inputs to one or more machine learning models to generate a curated natural language expression that provides an explanatory description of the gaming selection associated with the parameters and/or various winning conditions associated with the parameters. As previously discussed, the natural language expression can be presented in a user interface in multiple ways, depending on the user interface of the requesting device. For example, the natural language expression can be displayed as a tooltip or other type of text overlay, as a popup shown on player's demand, as an audio explanation using text-to-speech, or any other type of communication with the player as adequate. Additionally, or alternatively, providing the natural language expression can include generating a printed betslip which includes the natural language expression and a confirmation of the game selection. In still further examples, the documentation generated after successful game selection can be shown as a part of the game details (e.g., in player's gaming history), sent to player's email address, printed out on a retail ticket slip, etc.

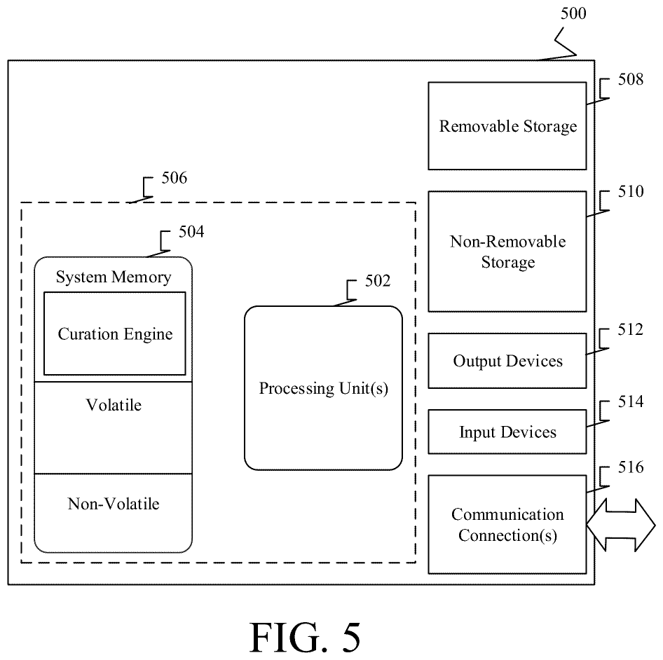

FIG. 5 illustrates a simplified block diagram of a device with which aspects of the present disclosure may be practiced, according to aspects described herein. The device may be a mobile computing device or a VR device for example. One or more of the present embodiments may be implemented in an operating environment 500. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 500 typically includes at least one processing unit 502 and memory 504. Depending on the exact configuration and type of computing device, memory 504 (instructions to perform for performing the aspects disclosed herein) may be volatile (such as RAM), non-volatile (such as ROM, flash memory, etc.), or some combination of the two. This most basic configuration is illustrated in FIG. 5 by dashed line 506. Further, the operating environment 500 may also include storage devices (removable, 508, and/or non-removable, 510) including, but not limited to, magnetic or optical disks or tape. Similarly, the operating environment 500 may also have input device(s) 514 such as remote controller, keyboard, mouse, pen, voice input, on-board sensors, etc. and/or output device(s) 512 such as a display, speakers, printer, motors, etc. Also included in the environment may be one or more communication connections, 516, such as LAN, WAN, a near-field communications network, a cellular broadband network, point-to-point, etc.

Operating environment 500 typically includes at least some form of non-transitory computer readable media. Computer readable media can be any available media that can be accessed by the at least one processing unit 502 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 500 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a sports wagering kiosk operable to receive wagering opportunities and display information about a wagering opportunities, wherein the sports wagering kiosk is further operable to transmit a request for a natural language expression describing the wagering opportunities via a network; and
a curation engine comprising at least one processor and memory encoding computer executable instructions that, when executed by the at least one processor, cause the curation to perform operations comprising:
receive gaming information from the sports wagering kiosk via the network;
analyze the gaming information to determine one or more gaming parameters;
generate, based upon the one or more gaming parameters, a curated natural language expression detailing the gaming selection; and
provide the curated natural language expression to the sports wagering kiosk.

2. The system of claim 1, wherein the gaming information is metadata associated with the request for the natural language expression.

3. The system of claim 1, wherein generating the curated natural language expression further comprises determining whether to use one or more templates, one or more machine learning models, or a combination to generate the curated natural language expression, wherein the determination is based upon the gaming parameters.

4. The system of claim 3, wherein, when the gaming information is at least one of a commonly placed bet or comprises older data, a template is used to generate the curated natural language expression.

5. The system of claim 4, wherein the generating the curated natural language expression further comprises:
accessing an index for a lookup table to identify an associated template;
retrieving the associated template; and
generating the curated natural language expression based upon the associated template and the gaming parameters.

6. The system of claim 3, wherein, when the gaming information is at least one of real-time data, related to a game currently in progress, or related to an uncommon bet, a machine learning model is used to generate the curated natural language expression.

7. The system of claim 6, wherein the generating the curated natural language expression further comprises:
generating one or more feature vectors based upon the gaming parameters;
analyzing the one or more feature vectors using the machine learning model to generate the curated natural language expression, wherein the one or more feature vectors are input signals to the machine learning model.

8. The system of claim 7, wherein analyzing the one or more feature vectors further comprises:
retrieving an associated template based upon the gaming parameters; and
providing the associated template as an additional input signal to the machine learning model.

9. A method comprising:
receiving a request for the natural language expression from a remote device via the network, wherein the request comprises gaming information;
analyzing the gaming information to determine one or more gaming parameters;
generating, based upon the one or more gaming parameters, a curated natural language expression detailing the gaming selection; and
providing the curated natural language expression to the remote device.

10. The method of claim 9, wherein the gaming information is metadata associated with the request for the natural language expression.

11. The method of claim 9, wherein generating the curated natural language expression further comprises determining whether to use one or more templates, one or more machine learning models, or a combination to generate the curated natural language expression, wherein the determination is based upon the gaming parameters.

12. The method of claim 11, wherein, when the gaming information is at least one of a commonly placed bet or comprises older data, a template is used to generate the curated natural language expression.

13. The method of claim 12, wherein the generating the curated natural language expression further comprises:
accessing an index for a lookup table to identify an associated template;
retrieving the associated template; and
generating the curated natural language expression based upon the associated template and the gaming parameters.

14. The method of claim 11, wherein, when the gaming information is at least one of real-time data, related to a game currently in progress, or related to an uncommon bet, a machine learning model is used to generate the curated natural language expression.

15. The system of claim 14, wherein the generating the curated natural language expression further comprises:
generating one or more feature vectors based upon the gaming parameters;
analyzing the one or more feature vectors using the machine learning model to generate the curated natural language expression, wherein the one or more feature vectors are input signals to the machine learning model.

16. The system of claim 15, wherein analyzing the one or more feature vectors further comprises:
retrieving an associated template based upon the gaming parameters; and
providing the associated template as an additional input signal to the machine learning model.

17. The method of claim 14, wherein the machine learning model is a generative machine learning model.

18. A non-tangible computer readable medium storing computer executable instructions that, when executed by at least one processor, cause the at least one processor to perform a method comprising:
receiving a request for the natural language expression from a sports betting application executing on a remote device via the network, wherein the request comprises gaming information;
analyzing the gaming information to determine one or more gaming parameters;
generating, based upon the one or more gaming parameters, a curated natural language expression detailing the gaming selection; and
providing the curated natural language expression to the remote device.

19. The non-tangible computer readable medium of claim 18, wherein generating the curated natural language expression further comprises determining whether to use one or more templates, one or more machine learning models, or a combination to generate the curated natural language expression, wherein the determination is based upon the gaming parameters.

20. The non-tangible computer readable medium of claim 19, when the gaming information is at least one of real-time data, related to a game currently in progress, or related to an uncommon bet, a generative machine learning model is used to generate the curated natural language expression.
